(19) United States
(12) Patent Application Publication
(10) Pub. No.: US 2012/0307839 A1
(43) Pub. Date: Dec. 6, 2012

(54) METHOD FOR RECEIVING CHANNEL SELECTION INFORMATION

(76) Inventors: Dumitru Mihai Ionescu, San Diego, CA (US); Abu Amanullah, San Diego, CA (US); Haidong Zhu, San Diego, CA (US)

(21) Appl. No.: 13/149,727

(22) Filed: May 31, 2011

(51) Int. Cl. H04L 12/28

(52) U.S. Cl. 370/431

(57) ABSTRACT

A master device selects a channel from a band of channels for communications with a slave device. The master transmits information identifying the selected to the slave device using a packet modulated as a series of energy pulses on the selected channel. The slave device performs wideband energy detection on the band of channels and receives the modulated pulses. The slave device decodes the modulated pulses to retrieve the selected channel, and tunes to the selected channel for further communications.

### TECHNICAL FIELD

The present invention relates generally to communication networks, and more particularly, some embodiments relate to methods for receiving channel selection information by an implanted medical device from an external communication device.

### DESCRIPTION OF HE RELATED ART

A wireless system for implanted medical devices consists of at least one implanted medical device (IMD) and an external communication device (ECD). The IMD (e.g., ICD, glucose monitor) monitors and treats physiological conditions within the human body. The ECD can be a device that is capable of communicating both with the implant and with a second device, perhaps using a different wireless system.

A MICS band has been allocated to serve applications for implanted medical devices (IMDs). The MICS band is between 402 to 405 MHz and consists of ten channels, each 300 KHz wide. FCC regulations in the US require that the ECD perform the clear channel assessment (CCA). While in other areas the IMD can send a periodic beacon, this is not the case in the US.

According to FCC regulations, the ECD must monitor a MICS band channel for at least 10 ms. After monitoring, it may then use the first unoccupied channel (it may use the best available channel if all channels are occupied). The ECD must have monitored the channel it decides to use during the past 5 sec. The ECD sends control information (a flag bit indicating whether the ECD has data to send, along with channel index info bits) on the selected channel, for IMD to use, should it have data to send.

The IMD must receive this periodic control information, and this functionality is assigned to a ultra low power wake-up service. In the worst case, the IMD must sequentially search through the ten channels in order to receive the control message from the ECD.

Some previous solutions to reduce the number of channels searched include use of a dedicated control channel. The IMD expects the channel index, and other control information, of the ECD's selected channel to be transmitted on a dedicated, preset, predetermined control channel. This is a common method used in the 2.4 GHz band.

Other solutions include the IMD beginning the sequential search always on the last channel used by the ECD. In this case, the ECD is configured to preferentially select the last used channel if available, thereby reducing the frequency of the IMD having to perform a sequential search.

### BRIEF SUMMARY OF EMBODIMENTS OF THE INVENTION

According to various embodiments of the invention, an ECD transmits channel selection information with spreading as amplitude modulated pulses on the channel it selects after CCA. An IMD performs wideband energy detection on the channel band, effectively searching all channels at once. The wideband energy detection detects the modulated pulses transmitted on the ECD's selected channel and demodulates the pulses to determine the selected channel. The IMD may then tune to the selected channel, in some cases using a separate radio system, to communicate with the ECD.

According to an embodiment of the invention, a method for a slave device to receive channel selection information from a master device, comprises: the master device selecting a channel of a band of channels for communications between the master device and the slave device; the master device transmitting channel selection information, which identifies the selected channel, as modulated pulses on the channel; the slave device performing wideband energy detection on the band of channels to detect the modulated pulses; the slave device demodulating the modulated pulses to determine the selected channel; and the slave device tuning to the selected channel for communications between the master device and the slave device.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a method for a master device to communicate channel selection information to a slave device.

FIG. 2 illustrates a transmission subsystem for a master device to transmit channel selection information to a slave device.

FIG. 3 illustrates a diagram of a band of channels and wideband energy monitoring.

FIG. 4 illustrates a receiver architecture for a slave device implemented in accordance with an embodiment of the invention.

FIG. 5 illustrates an example computing module that may be used in implementing various features of embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for communicating channel selection information from a master device to a slave device. In one embodiment, the slave device comprises an implanted medical device (IMD) that monitors or treats physiological conditions within the human body, such as an implantable cardioverter-defibrillator (ICD) or glucose monitor, and the master device comprises an external communications device that is capable of communicating both with the implant and with a second device, perhaps using a different wireless system. In a particular embodiment, the devices communicate according to the standards associated with the Medical Implant Communication Service (MICS).

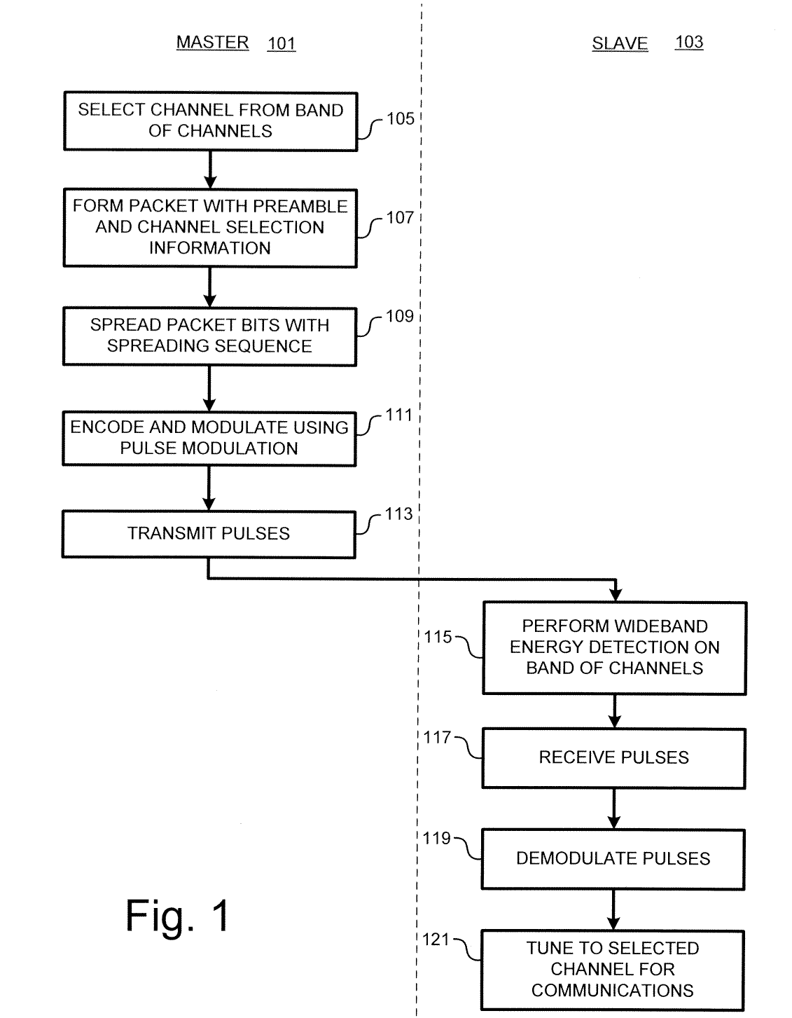

FIG. 1 illustrates a method for a master device to communicate channel selection information to a slave device. In step 105, a master device 101 selects a channel from an available band of channels. For example, in MICS communications, the available band of channels may be the allocated band from 402 to 405 MHz, and the channels may comprise the ten 300 kHz channels which make up the band. In some embodiments, the step 105 of selecting a channel may comprise performing clear channel assessment (CCA) on the band of channels to determine if a channel is unoccupied. If all channels are occupied, the CCA can be used to determine which channel is the clearest. This selected channel will be used for subsequent communications between the master 101 and the slave 103. For example, the channel may be used for data or instruction transmissions from the master 101 or data reports from the slave 103.

With the channel selected in step 105, the master device performs step 107 to form a packet comprising preamble bits and channel selection information bits. The preamble bits may be used for various purposes, such as synchronization. The channel selection information bits identify the master's 101 selected channel. In further embodiments, the packet may contain other information. Such additional information may include an information element identifying the master 101, such as ID packet bits or a unique correlation signature such as a unique preamble or spreading signature corresponding to the master device 101. The additional information may also include traffic indication bits that indicate that the master 101 has data to transmit to the slave 103, or other additional information.

In step 109, the packet bits are spread with a spreading sequence. In some embodiments, this spreading sequence may correspond to the specific master 101, allowing the slave 103 to identify the master 101. In other embodiments, the spreading sequence may comprise other conventional spreading sequences. In the illustrated embodiment, the spreading increases the dimensions, or time-bandwidth product, of the transmitted pulses. In some embodiments, the spreading may be across the entire selected channel. For example, in an MICS system, the spreading may be up to 300 kHz.

The spread packet is then encoded and modulated in step 111. In some embodiments, the step of encoding 111 comprises encoding the spread information bits, such as the channel identification index, and any traffic indications or transmitter identifications, using a forward error correction (FEC) code and a corresponding set of codewords. In some embodiments, the FEC code may comprise a BCH code, such as a (31, 6) BCH code, or a Golay perfect code, such as a (23, 12) Golay perfect code. In other embodiments, other conventional FEC codes may be utilized, including cyclic codes or codes having other properties. The packet is then modulated 111 as a series of energy pulses on the channel, for example using on-off keying (OOK).

The preamble is added to allow packet synchronization. The preamble may be selected to have acceptable aperiodic correlation properties to allow the slave device 103 to synchronize. In some embodiments, the preamble is further selected to avoid significantly affecting power consumption at the receiver end at slave 103 when averaged over the ensemble of all operational modes. As described below, some embodiments may be configured such that the slave device 103 performs a sequential channel search over the channel band if the wideband energy detection fails. In these embodiments, the preamble may be further configured to accommodate codeword repetitions during the sequential search mode. In step 113, the pulses are then transmitted on the selected channel.

In some embodiments, the slave device 103 may be configured to sleep between communication periods and wake up to receive updated channel information for the current communication period. In step 115, the slave device 103 performs wideband energy detection on the channel band. The wideband energy detection preferably monitors the entire band at once; the master's 101 transmitted pulses on a single channel are detected as energy pulses on the band. For example, in an MICS system, the slave 103 may use a band filter at 402-405 MHz to monitor all 10 channels of the MICS channel band.

In this embodiment, the slave device 103 uses the transmitted preamble to synchronize to the packet to identify the beginning of the integration interval for energy detection. In some embodiments, this may comprise oversampling, for example, on an order of 2 or more, to address frequency instability. Once the slave 103 has synchronized to the master's 101 transmission, the slave device 103 may receive the pulses 117 by measuring the duration of each pulse after an envelope detector detects an energy pulse.

In step 119, the slave 103 may demodulate the pulses and decode the received codeword to receive the transmitted information. For example, the slave 103 can determine the master's 101 selected channel; and in some embodiments, the master's 101 identity and whether the master 101 has data for the slave 103. When the slave 103 determines the selected channel, in step 121, the slave 103 tunes to the master's 101 selected channel for communications with the master. In some embodiments, the slave 103 may have two receiver subsystems, one for the wideband energy detection and a second to communicate data with the master 101 after the channel has been communicated. For example, the slave 103 my utilize a super-regenerative receiver for wideband energy detection and a heterodyne receiver for data communications with the master 101. In other embodiments, the slave 103 may utilize a single receiver for both functions, or may utilize certain components for both functions.

In further embodiments, the master and slave device may be configured to detect if the above method will not function, for example, in the case of a poor signal-to-noise ratio. In this case, the slave 103 may enter a fold-back option that implements another method of receiving channel selection information from the master 101. For example, the master 101 and slave 103 may enter a sequential search mode, where the slave device sequentially monitors each channel of the band of channels to determine which channel the master 101 is communicating on.

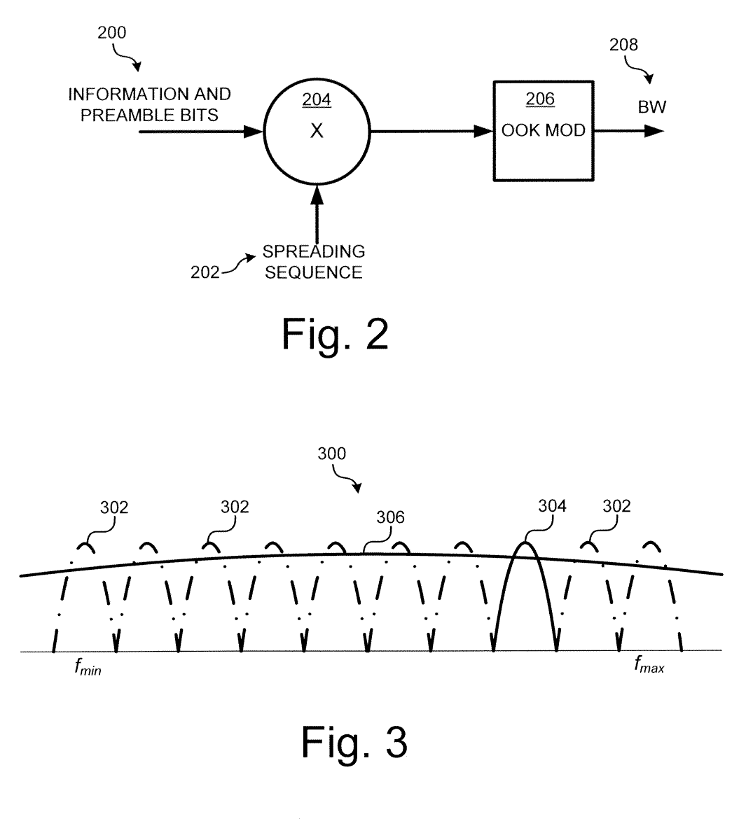

FIG. 2 illustrates a transmission subsystem for a master device to transmit channel selection information to a slave device. In this embodiment, a mixer 204 mixes information and preamble bits 200 with a spreading sequence 202. As discussed above, the information bits 200 may include channel selection information, and other information such as traffic indication information or transmitter identification information. As discussed above, the preamble bits 200 may include various hits to assist in packet synchronization, and in some embodiments may be selected to identify the master device. In a particular embodiment, the information and preamble bits are presented at a rate of about 20 kb/s. The spreading sequence 202 is configured to increase the time-bandwidth product of the signal by spreading the bits 200 across the selected channel. In the illustrated embodiment, the spread bits are then modulated in OOK modulator 206. The final signal 208 has an increased time bandwidth product, utilizing the bandwidth of the selected channel. For example, in an MICS system, the bandwidth may be about 200 KHz.

FIG. 3 illustrates a diagram of a band of channels and wideband energy monitoring. Band 300 comprises a plurality of channels 302 from a first frequency to a second frequency. For example, in an MICS system, the band runs from 402 to 405 MHz, with ten 300 kHz channels. Accordingly, the center frequency of the first channel is 402.15 MHz and the center frequency of the tenth channel is 404.85 MHz. In typical environments, some the channels 302 may be occupied by other master-slave device pairs. In one embodiment, a master device performs a CCA to determine if a channel is unoccupied, or which channels are clearest if all channels are occupied. After the CCA, the master device selects a channel 304 for communications. The slave device monitors the channel 300's bandwidth 306 using a wideband receiver. Accordingly, the slave device receives 306 the information transmitted on the master's selected channel 304. If any of the other channels 302 are occupied by other master-slave pairs, then the energy transmitted on these channels 302 will also be received with the slave's receiver of bandwidth 306. As discussed below, the wideband monitoring 306 of the channel band 300 with the master transmitting pulses on channel 304 may be modeled as a binary asymmetric channel, with the energy from these interfering pairs modeled as part of the noise uncertainty for the binary asymmetric channel.

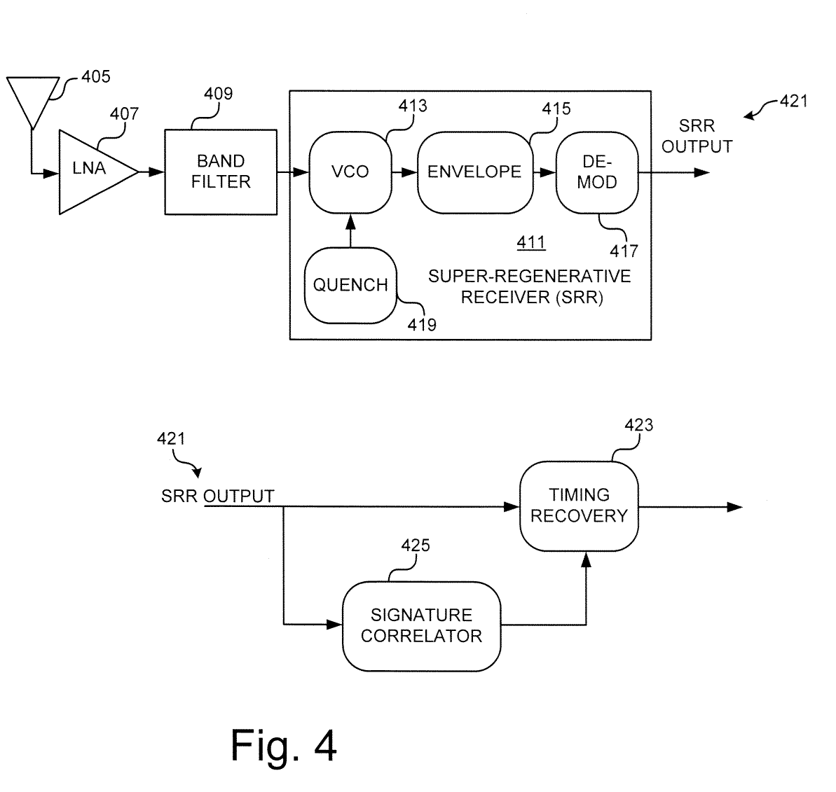

FIG. 4 illustrates a receiver architecture for a slave device implemented in accordance with an embodiment of the invention. In the front end, a wideband antenna 405 receives energy and is amplified by low noise amplifier (LNA) 407. The amplified signal is band pass filtered according to the channel band being used for communications at band pass filter 409. For example, in an MICS system, band pass filter 409 may comprises a MICS band pass filter that passes frequencies from 402 to 405 MHz. The filtered signal is provided to a receiver 411 for demodulation.

In the illustrated embodiment, the receiver 411 is a super-regenerative receiver (SRR). A SRR can act as a wideband energy detector and because it does not require a mixer can save power over other receivers. However, in other embodiments, other receivers, such as superheterodyne receivers may be used. In the SRR 411, a voltage controlled oscillator 413 resonates with the signal from band filter 409 at an RF oscillation frequency. A quench oscillation 419 periodically interrupts or quenches the RF oscillation. After each quenching, the oscillation grows exponentially. In various implementations, the amplitude reached at the end of the quench cycle, or the time taken to reach a limiting amplitude depend on the strength of the received signal. The quench oscillation 419 thereby determines the sampling rate of the received signal. In various embodiments, quench signals may be used that provide sampling rates in the range of about 2 to about 10 times the baud rate of the signal. An envelope detector 415 is configured to remove the quench signal and RF frequencies and recover the modulated pulses. The demodulator 417 assesses the energy by measuring the duration of a pulse after the envelope detection 415, and decides between two detection hypotheses:

H₀:Y[n]=W[n]

H₁:Y[n]=X[n]+W[n]

where X[•] represents the transmitted signal, WV[•] are the noise samples contributed by other interference devices on the band, and Y[•] denotes received samples. This provides an SRR output 421 comprising a sequence of un-synchronized digital pulses. As discussed above, the preamble may then be used to achieve packet-level synchronization.

In some embodiments, the transmitted packet of energy pulses may include information that identifies the master device. For example, in one embodiment, the master device might be an external communication device, perhaps configured as a medical bracelet for a medical patient to wear, that communicates with one or more various implanted medical devices. Information that identifies the master device in the energy pulse packet, such as a unique preamble or a unique spreading signature, allows the slave device to identify a received energy pulse packet even in the presence of other master devices that are paired with other slave devices. In the illustrated embodiment, the identifying information comprises a unique preamble. In step 425, the preamble is correlated with a copy of the preamble stored locally by the slave device. This correlation is used in packet timing recovery in step 423. In various embodiments, such preambles may be chosen to have low aperiodic cross-correlation and large aperiodic auto-correlation to allow for both synchronized timing recovery and master device identification. After timing recover 423, the coded bits can now be detected and decoded to extract the channel index and any flag bits or other information.

As discussed above, in typical environments, other master-slave device pairs will frequently be communicating on other channels of the channel bands. When a slave device implements wideband energy detection to detect the packet of energy pulses from its associated master device, these other communications can be modeled as part of the noise uncertainty on the effective channel (which comprises the entire band of actually allocated channels). In typical environments where the master device is outside in close proximity to a patient and the slave device is implanted in the patient, the worst-case design scenario is Rayleigh fading for the propagation path of the signal to be detected. The noise uncertainty, U, in this situation, may be found to be:

$$U = \frac{ln ( 1 - \sqrt{1 - 4 {P}_{FA ; agg}} ) - ln 2}{ln \sqrt{{P}_{D ; agg}}} ,$$

where P_{FA;agg} is the overall false alarm probability and P_{D,agg} is the overall detection probability. This noise uncertainty determines the minimum required signal-to-noise ratio SNR, which may be found to be:

$$SNR \geq U - 1 + U \frac{b \sqrt{γ}}{\sqrt{TB}} + \frac{a}{TB} ( a - \sqrt{{a}^{2} ( 2 U - 1 ) TB γ + 2 \sqrt{TB} b \sqrt{γ}} ) ,$$

where a=Q⁻¹(P_{D;des}), b=Q⁻¹(P_{FA;des}), Q(•) is the Q-function,

$$Q ( x ) = \frac{1}{2} erfc ( \frac{x}{\sqrt{2}} ) = \frac{1}{\sqrt{2 π}} {\int }_{x}^{∞} exp ( - {y}^{2} / 2 ) d y ,$$

TB is the time bandwidth product, and γ is the factor by which the detector's bandwidth exceeds the signal's bandwidth (for example, in the MICS embodiments, with 10 channels being monitored by the slave, and once channel used by the master, γ≈10. With selection of the aggregate target values for detection and false alarm probabilities, this defines an effective binary asymmetric channel that will convey the message from the master device to the slave, typically a FEC codeword.

As illustrated above, determination of the minimum required SNR for a desired false alarm probability and detection probability does not require knowledge of the noise power contributed by other devices, such as narrow-band interferers, communicating on the channel. However, in some embodiments, information about the absolute noise power of potential interfering devices may be useful. In such embodiments, the preamble, for example preamble bits 200, may be used to perform delay correlation in order to infer information about and model the absolute, i.e. not relative, noise power contributed by other devices on the channel.

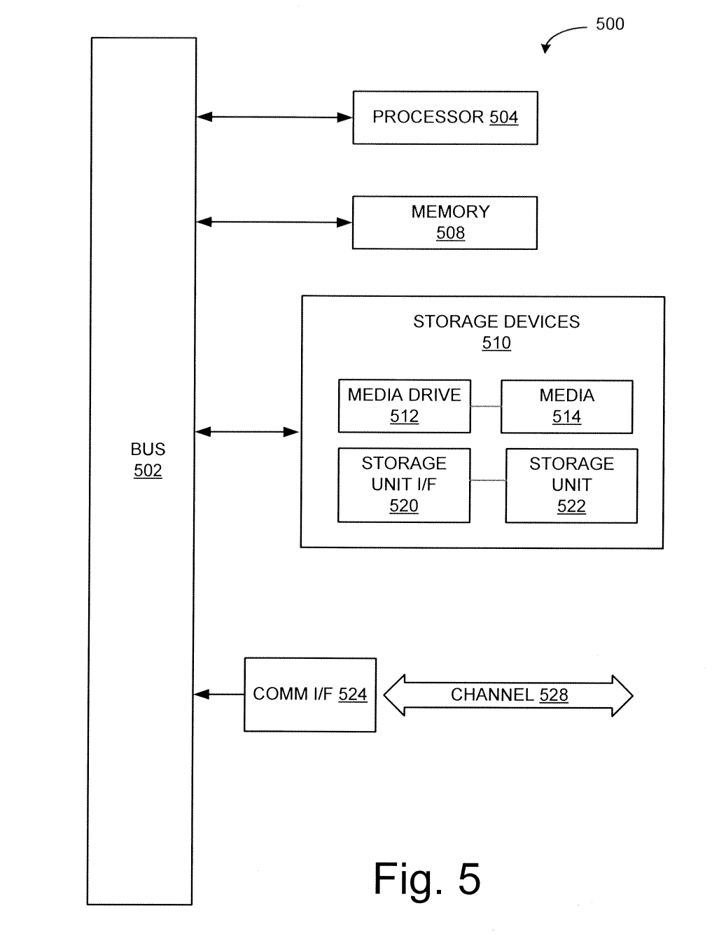

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example-computing module 500. After reading this description, it will become apparent to a person skilled in the relevant art how to implement the invention using other computing modules or architectures.

Referring now to FIG. 5, computing module 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 500 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 500 might include, for example, one or more processors, controllers, control modules, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing module 500 or to communicate externally.

Computing module 500 might also include one or more memory modules, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Computing module 500 might likewise include a read only memory (“ROM”) or other static storage device coupled to bus 502 for storing static information and instructions for processor 504.

The computing module 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing module 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory module) and memory slot, a PCMCIA slot and card, and other fixed or removable storage units 522 and interfaces 520 that allow software and data to be transferred from the storage unit 522 to computing module 500.

Computing module 500 might also include a communications interface 524. Communications interface 524 might be used to allow software and data to be transferred between computing module 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 5 00 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for a slave device to receive channel selection information from a master device, comprising:
the master device selecting a channel of a band of channels for communications between the master device and the slave device;
the master device transmitting channel selection information, which identifies the selected channel, as modulated pulses on the channel;
the slave device performing wideband energy detection on the band of channels to detect the modulated pulses;
the slave device demodulating the modulated pulses to determine the selected channel; and
the slave device tuning to the selected channel for communications between the master device and the slave device.

2. The method of claim 1, further comprising the master device encoding the channel selection information as the modulated pulses using an error correction code.

3. The method of claim 2, further comprising the master device encoding the modulated pulses using on-off keying.

4. The method of claim 1, further comprising the slave device sequentially scanning the channels of the band of channels if the slave device fails to detect the modulated pulses using the wideband energy detection on the band of channels.

5. The method of claim 1, further comprising the master device spreading the channel selection information using a spreading sequence.

6. The method of claim 1, wherein the modulated pulses further comprise a synchronization preamble.

7. The method of claim 1, wherein the modulated pulses further comprise a traffic indication flag.

8. The method of claim 1, wherein the modulated pulses further comprise an information element identifying the master device.

9. The method of claim 1, further comprising the master device transmitting a preamble to the channel selection information; and the slave device performing delay correlation on the preamble to determine noise power of interfering devices present on the channel.

10. A method for a slave device to receive channel selection information from a master device, comprising:
the slave device performing wideband energy detection on a band of channels to detect modulated pulses transmitted by the master device, wherein the modulated pulses are transmitted on a selected channel of the band of channels for communications between the master device and the slave device, and wherein the modulated pulses convey channel selection information;
the slave device demodulating the modulated pulses to determine the selected channel; and
the slave device tuning to the selected channel for communications between the master device and the slave device.

11. The method of claim 10, wherein the channel selection information transmitted as the modulated pulses is encoded using an error correcting code.

12. The method of claim 11, wherein the channel selection information transmitted as the modulated pulses is transmitted using on-off keying.

13. The method of claim 10, further comprising the slave device sequentially scanning the channels of the band of channels if the slave device fails to detect the modulated pulses using the wideband energy detection on the band of channels.

14. The method of claim 10, wherein the channel selection information is spread on the channel.

15. The method of claim 10, wherein the modulated pulses further comprise a synchronization preamble.

16. The method of claim 10, wherein the modulated pulses further comprise a traffic indication flag.

17. The method of claim 10, wherein the modulated pulses further comprise an information element identifying the master device.

18. The method of claim 10, further comprising the slave device determining noise power of interfering devices present on the channel by performing delay correlation on a preamble transmitted by the master device with the channel selection information.

19. A method for a master device to transmit channel selection information to a slave device, comprising:
the master device selecting a channel of a band of channels for communications between the master device and the slave device;
the master device transmitting channel selection information, which identifies the selected channel, as modulated pulses on the channel;
wherein the modulated pulses are configured to be detected by the slave device performing wideband energy detection on the band of channels.

20. The method of claim 19, further comprising the master device encoding the channel selection information as the modulated pulses using an error correction code.

21. The method of claim 20, further comprising the master device encoding the modulated pulses using on-off keying.

22. The method of claim 19, further comprising the master device spreading the channel selection information using a spreading sequence.

23. The method of claim 19, wherein the modulated pulses further comprise a synchronization preamble.

24. The method of claim 19, wherein the modulated pulses further comprise a traffic indication flag.

25. The method of claim 19, wherein the modulated pulses further comprise an information element identifying the master device.

26. The method of claim 19, further comprising the master device transmitting a preamble with the channel selection information, the preamble configured to enable the slave device to perform delay correlation on the preamble to determine noise power of interfering devices present on the channel.

27. A slave device, comprising:
hardware or software stored on a non-transitory computer readable medium configured to perform operations comprising:
the slave device performing wideband energy detection on a band of channels to detect modulated pulses transmitted by the master device, wherein the modulated pulses are transmitted on a selected channel of the band of channels for communications between the master device and the slave device, and wherein the modulated pulses convey channel selection information;
the slave device demodulating the modulated pulses to determine the selected channel; and
the slave device tuning to the selected channel for communications between the master device and the slave device.

28. The device of claim 27, wherein the channel selection information transmitted as the modulated pulses is encoded using an error correcting code.

29. The device of claim 28, wherein the channel selection information transmitted as the modulated pulses is transmitted using on-off keying.

30. The device of claim 27, wherein the operations further comprise the slave device sequentially scanning the channels of the band of channels if the slave device fails to detect the modulated pulses using the wideband energy detection on the band of channels.

31. The device of claim 27, wherein the channel selection information is spread on the channel.

32. The device of claim 27, wherein the modulated pulses further comprise a synchronization preamble.

33. The device of claim 27, wherein the modulated pulses further comprise a traffic indication flag.

34. The device of claim 27, wherein the modulated pulses further comprise an information element identifying the master device.

35. The device of claim 27, wherein the operations further comprise the slave device the slave device determining noise power of interfering devices present on the channel by performing delay correlation on a preamble transmitted by the master device with the channel selection information.

36. A master device, comprising:
hardware or software stored on anon-transitory computer readable medium configured to perform operations comprising:
the master device selecting a channel of a band of channels for communications between the master device and the slave device;
the master device transmitting channel selection information, which identifies the selected channel, as modulated pulses on the channel;
wherein the modulated pulses are configured to be detected by the slave device performing wideband energy detection on the band of channels.

37. The device of claim 36, wherein the operations further comprise the master device encoding the channel selection information as the modulated pulses using an error correction code.

38. The device of claim 37, wherein the operations further comprise the master device encoding the modulated pulses using on-off keying.

39. The device of claim 36, wherein the operations further comprise the master device spreading the channel selection information using a spreading sequence.

40. The device of claim 36, wherein the modulated pulses further comprise a synchronization preamble.

41. The device of claim 36, wherein the modulated pulses further comprise a traffic indication flag.

42. The device of claim 36, wherein the modulated pulses further comprise an information element identifying the master device.

43. The device of claim 36, wherein the operations further comprise the master device the master device transmitting a preamble with the channel selection information, the preamble configured to enable the slave device to perform delay correlation on the preamble to determine noise power of interfering devices present on the channel.
